(19) United States
(12) Patent Application Publication
(10) Pub. No.: US 2026/0361940 A1
(43) Pub. Date: Nov. 12, 2026

(54) VIDEO REPRODUCTION DEVICE, VIDEO REPRODUCTION METHOD, AND VIDEO REPRODUCTION PROGRAM

(71) Applicant: NTT, Inc, Tokyo (JP)

(72) Inventors: Yasuhiro MOCHIDA, Musashino-shi, Tokyo (JP); Kohei MIZUNO, Musashino-shi, Tokyo (JP); Takuro YAMAGUCHI, Musashino-shi, Tokyo (JP)

(73) Assignee: NTT, Inc, Tokyo (JP)

(21) Appl. No.: 19/139,874

(22) PCT Filed: Dec. 20, 2022
(86) PCT No.: PCT/JP2022/046878

§ 371 Date: Jun. 17, 2025

(51) Int. Cl. H04N 21/262

(52) U.S. Cl. CPC H04N 21/2625

(57) ABSTRACT

A buffer unit that receives and stores a packet transmitted via a network, a setting unit that sets a reproduction offset (a) that enables reproduction of video data included in the packet according to a condition of the network, and a reproducing unit that delays the video data by the reproduction offset (a) and outputs the delayed video data are provided.

### TECHNICAL FIELD

The present invention relates to a video reproduction device, a video reproduction method, and a video reproduction program.

### BACKGROUND ART

For a video transmission protocol used for video communication, Non Patent Literatures 1 and 2 disclose that a reproduction time of a received video is determined based on an absolute time such as a Coordinated Universal Time (UTC) or International Atomic Time (TAI). Non Patent Literatures 1 and 2 disclose that a transmission device and a reproduction device acquire a current time in TAI by Precision Time Protocol (PTP) and store video data in a Real-time Transport Protocol (RTP) packet.

Meanwhile, Non Patent Literatures 3 and 4 disclose a technique for setting timings of videos and audios. The reproduction device disclosed in Non Patent Literature 1 reproduces video data of the received RTP packet in accordance with a frame boundary defined by the methods disclosed in Non Patent Literatures 3 and 4.

### CITATION LIST

### Non Patent Literature

Non Patent Literature 1: SMPTE ST 2110-10, Professional MediaOver Managed IP Networks: SystemTiming and Definitions.
Non Patent Literature 2: SMPTE ST 2110-20, Professional MediaOver Managed IP Networks: Uncompressed Active Video.
Non Patent Literature 3: SMPTE ST 2059-1, Generation and Alignment of Interface Signals to the SMPTE Epoch.
Non Patent Literature 4: SMPTE ST 2059-2, SMPTE Profile for Use of IEEE-1588 Precision Time Protocol in Professional Broadcast Applications.

### SUMMARY OF INVENTION

### Technical Problem

However, in a case where video data of a RTP packet received by the reproduction device is reproduced in accordance with the next frame boundary by using the technique disclosed in Non Patent Literatures 1 to 4 disclosed above, there is a problem that a reproduction delay at the time of video reproduction increases.

That is, when the transmission processing delay of the transmission device is set as ds, the reproduction processing delay of the reproduction device is set as dr, and the network delay is set as dn, the transmission delay Dt can be expressed by the following Expression (1).

Dt=ds+dr+dn (1)

The network delay dn expressed by Expression (1) includes delay jitter.

In Expression (1) above, even if the transmission delay Dt is 1 [msec], in a case where reproduction is performed in accordance with the next frame boundary, if the frame rate is 60 [fps], the reproduction time is after about 16.7 [msec] (1 frame), and a large delay occurs. However, in Non Patent Literatures 1 to 4 described above, reduction in the reproduction delay is not considered.

In the RTP packets disclosed in Non Patent Literatures 1 and 2, the current time at the time of transmission is stamped in an RTP time stamp area of an RTP header by the transmission device. Here, in order to reduce the reproduction delay, it is conceivable that the time obtained by adding a reproduction offset a to the RTP time stamp of the received video data be set to be the reproduction time of the video data.

However, at the time of transmission of the RTP packet, delay jitter that varies for each RTP packet is added to the network delay dn, and therefore the network delay dn varies. Thus, in order to stably reproduce video data, it is necessary to set the reproduction offset a to be always equal to or larger than the transmission delay Dt, that is, to always set “a≥Dt”.

Therefore, in order to stably reproduce the video data with a low delay, it is necessary to appropriately set the reproduction offset a according to the network conditions.

The present disclosure has been made in view of the above circumstances, and an object of the present disclosure is to provide a video reproduction device, a video reproduction method, and a video reproduction program capable of stably reproducing video data with a low delay.

### Solution to Problem

According to an aspect of the present disclosure, a video reproduction device includes a buffer unit that receives and stores a packet transmitted via a network, a setting unit that sets a reproduction offset which enables reproduction of video data included in the packet according to a condition of the network, and a reproducing unit that delays the video data by the reproduction offset and outputs the delayed video data.

According to another aspect of the present disclosure, a video reproduction method includes receiving a packet transmitted via a network, setting a reproduction offset that enables reproduction of video data included in the packet according to a condition of the network, and delaying the video data by the reproduction offset and outputting the delayed video data.

According to still another aspect of the present disclosure, a video reproduction program causes a computer to function as the above video reproduction device.

### Advantageous Effects of Invention

According to the present disclosure, it is possible to stably reproduce video data with a low delay.

### BRIEF DESCRIPTION OF DRAWINGS

FIG. 1 is a block diagram illustrating a configuration of a video reproduction device according to a first embodiment.

FIG. 2 is a flowchart illustrating an example of an operation of the video reproduction device according to the first embodiment.

FIG. 3 is a block diagram illustrating a configuration of a video reproduction device according to a second embodiment.

FIG. 4 is a flowchart illustrating an example of an operation of the video reproduction device according to the second embodiment.

FIG. 5 is a block diagram illustrating a configuration of a video reproduction device according to a third embodiment.

FIG. 6 is a block diagram illustrating a configuration of a communication system to which the video reproduction device according to the third embodiment is connected.

FIG. 7 is a flowchart illustrating an example of an operation of the video reproduction device according to the third embodiment.

FIG. 8 is a block diagram illustrating a configuration of a video reproduction device according to a fourth embodiment.

FIG. 9A is an explanatory diagram illustrating a connection configuration of each fiber.

FIG. 9B is a diagram illustrating a relationship between a fiber number and a fiber length of each fiber.

FIG. 10 is a flowchart illustrating an example of an operation of the video reproduction device according to the fourth embodiment.

FIG. 11 is a block diagram illustrating a hardware configuration of the present embodiment.

### DESCRIPTION OF EMBODIMENTS

Hereinafter, embodiments will be described with reference to the drawings.

### Description of First Embodiment

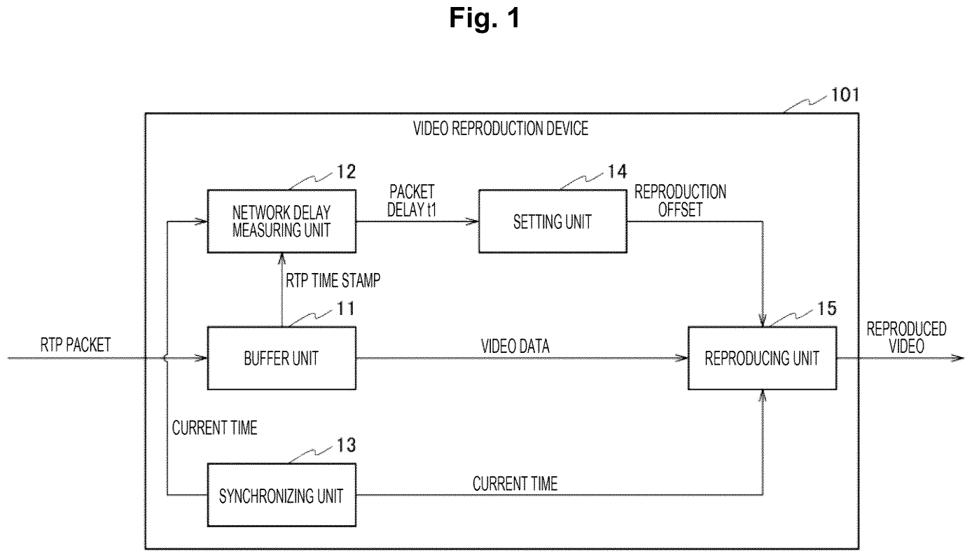

FIG. 1 is a block diagram illustrating a configuration of a video reproduction device 101 according to a first embodiment. As illustrated in FIG. 1, the video reproduction device 101 includes a buffer unit 11, a network delay measuring unit 12, a synchronizing unit 13, a setting unit 14, and a reproducing unit 15.

The video reproduction device 101 receives a Real-time Transport Protocol (RTP) packet transmitted from a transmission device (not illustrated) via a network, delays video data included in the received RTP packet by a reproduction offset a, and outputs the delayed video data to a subsequent device as a reproduced video.

The buffer unit 11 receives and temporarily stores an RTP packet transmitted via the network. The buffer unit 11 extracts an RTP time stamp from the RTP packet and outputs the RTP time stamp to the network delay measuring unit 12 and the reproducing unit 15.

The synchronizing unit 13 outputs the current time to the network delay measuring unit 12 and the reproducing unit 15. The current time output from the synchronizing unit 13 enables the network delay measuring unit 12 and the reproducing unit 15 to synchronize the current time.

The network delay measuring unit 12 calculates a difference time between the RTP time stamp output from the buffer unit 11 and the current time acquired from the synchronizing unit 13, based on this RTP time stamp and this current time a plurality of times. The network delay measuring unit 12 sets the maximum value of the calculated difference time as a packet delay t1. The packet delay t1 can be considered as a numerical value corresponding to a network delay dn in one direction (one way).

The packet delay may cause delay jitter for various reasons. Therefore, the difference time between the RTP time stamp and the current time varies. The network delay measuring unit 12 measures the difference time between the time stamp included in the packet and the current time a plurality of times, and sets the maximum value among the measured difference times as the packet delay t1.

Note that a method of adopting the maximum value is an example, and other numerical values may be used as the packet delay t1. For example, a time obtained by further adding a predetermined time α to the maximum value of the difference time may be set as the packet delay t1. The network delay measuring unit 12 outputs the packet delay t1 to the setting unit 14.

The setting unit 14 calculates a transmission delay Dt by the following Expression (3) based on the packet delay t1.

Dt=ds+dr+t1 (3)

Here, ds indicates a transmission processing delay of the transmission device, and dr indicates a reproduction processing delay of the reproduction device. Note that, in the present embodiment and each embodiment described later, the transmission processing delay ds and the reproduction processing delay dr are assumed to be constant values and known numerical values.

The setting unit 14 sets the transmission delay Dt calculated in Expression (3) above as the reproduction offset a. That is, the setting unit 14 sets the reproduction offset a based on the packet delay t1. Note that, since delay jitter larger than that at the time of measurement may occur, a numerical value obtained by adding a margin to the transmission delay Dt may be set as the reproduction offset a.

That is, the setting unit 14 sets the reproduction offset a that enables reproduction of video data included in the packet according to a condition of the network (packet delay at the time of packet transmission). The setting unit 14 outputs the calculated reproduction offset a to the reproducing unit 15.

The reproducing unit 15 acquires the current time output from the synchronizing unit 13, the reproduction offset a output from the setting unit 14, and the video data output from the buffer unit 11. The reproducing unit 15 outputs the video data to the subsequent device at a time at which the reproduction offset a is added to the RTP time stamp of the video data. That is, the reproducing unit 15 delays the video data by the reproduction offset a and outputs the delayed video data.

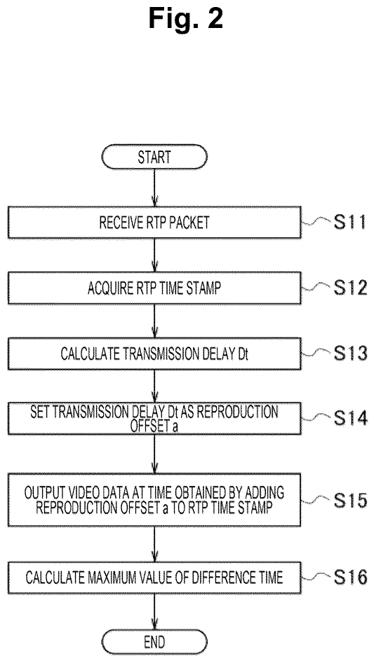

Next, an operation of the video reproduction device 101 according to the first embodiment will be described with reference to the flowchart illustrated in FIG. 2.

First, in Step S11 in FIG. 2, the buffer unit 11 receives an RTP packet transmitted from a transmission device (not illustrated) via a network. The RTP packet includes an RTP time stamp and video data. The buffer unit 11 outputs the RTP time stamp to the network delay measuring unit 12. The buffer unit 11 outputs the RTP time stamp and the video data to the reproducing unit 15.

In Step S12, the network delay measuring unit 12 acquires the RTP time stamp. The network delay measuring unit 12 calculates a packet delay t1 based on the RTP time stamp and the current time output from the synchronizing unit 13.

In Step S13, the setting unit 14 calculates a transmission delay Dt by Expression (3) described above.

In Step S14, the setting unit 14 sets the transmission delay Dt as the reproduction offset a. The setting unit 14 outputs the reproduction offset a to the reproducing unit 15.

In Step S15, the reproducing unit 15 outputs the video data to the subsequent device at a time at which the reproduction offset a is added to the RTP time stamp of the video data.

In Step S16, the network delay measuring unit 12 calculates the maximum value of the difference time between the RTP time stamp and the current time, which is calculated a plurality of times, and sets the difference time as the packet delay t1. Due to the maximum value of the difference time being set as the packet delay t1, it is possible to set the reproduction offset a that enables avoidance of the influence of the delay jitter. As a result, it is possible to stably output the video data with a low delay.

As described above, the video reproduction device 101 according to the first embodiment includes: the buffer unit 11 that receives and stores a packet transmitted via the network; the setting unit 14 that sets the reproduction offset a which enables reproduction of video data included in the packet according to the condition of the network; and the reproducing unit 15 that delays the video data by the reproduction offset a and outputs the delayed video data.

In the present embodiment, the difference time between the RTP time stamp and the current time is measured a plurality of times, the maximum value of the difference time is set as the packet delay t1 (corresponding to the network delay dn), and the transmission delay Dt is calculated by Expression (3) described above. Further, the transmission delay Dt is set as the reproduction offset a.

Therefore, even if large delay jitter is caused at the time of packet transmission, it is possible to stably output the video data. Therefore, it is possible to minimize the delay at the time of reproduction as much as possible and stably output the video data.

In the present embodiment, the maximum value of the difference time between the RTP time stamp and the current time is set as the packet delay t1, and the reproduction offset a is set by using the packet delay t1. Therefore, it is possible to set the reproduction offset a by performing a very simple calculation, and to reduce the calculation load of the device.

In the video reproduction device 101 according to the present embodiment, it is possible to shorten the reproduction delay time. Therefore, it is possible to implement applications such as remote communication, remote chorus, and remote surgery with a low delay.

### Description of Second Embodiment

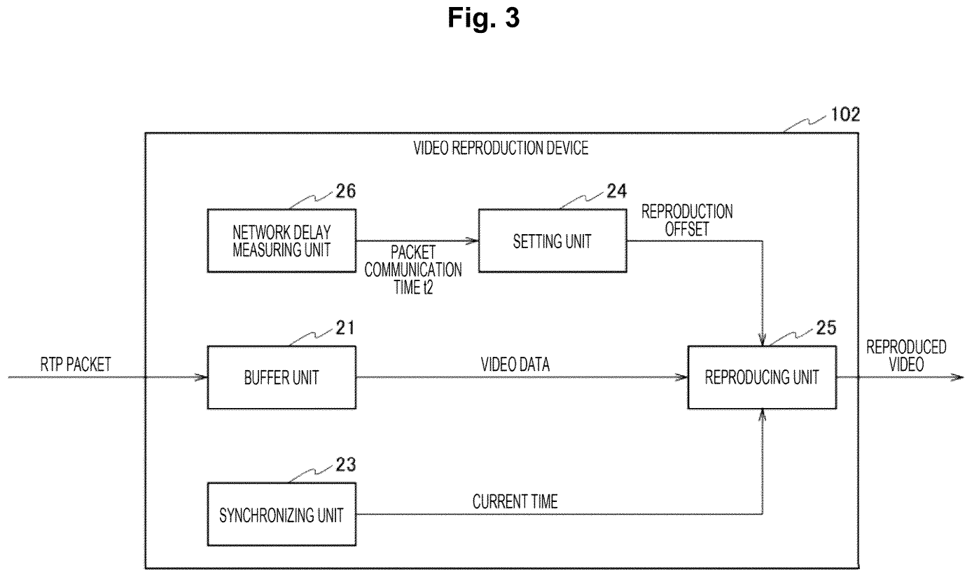

Next, a second embodiment will be described. FIG. 3 is a block diagram illustrating a configuration of a video reproduction device 102 according to a second embodiment. In the second embodiment, a packet communication time between a transmission device (not illustrated) and the video reproduction device 102 is measured, and the reproduction offset a is set based on the measurement result.

As illustrated in FIG. 3, the video reproduction device 102 includes a buffer unit 21, a network delay measuring unit 26, a synchronizing unit 23, a setting unit 24, and a reproducing unit 25.

The buffer unit 21 receives and temporarily stores an RTP packet transmitted from a transmission device (not illustrated) via the network. The buffer unit 21 outputs an RTP time stamp and video data included in the RTP packet to the reproducing unit 25.

The synchronizing unit 23 outputs the current time to the reproducing unit 25.

The network delay measuring unit 26 measures a packet communication time t2 between the transmission device (not illustrated) and the video reproduction device 102 by using a PING value. The PING value refers to a time required for transmission and reception of data.

The packet communication time t2 indicates a communication time required for round-trip between the transmission device and the video reproduction device 102. Therefore, a time (t2/2) that is ½ of the packet communication time t2 can be considered as a numerical value corresponding to the network delay dn during one-way communication (one-way). That is, the packet communication time t2 varies according to the conditions of the network. The network delay measuring unit 26 measures the packet communication time t2 a plurality of times in order to consider delay jitter, and adopts the maximum value among the measured packet communication times. The network delay measuring unit 26 outputs the maximum packet communication time t2 to the setting unit 24.

The setting unit 24 acquires the packet communication time t2 and calculates the transmission delay Dt by the following Expression (4).

Dt=ds+dr+t2/2 (4)

Here, ds indicates a transmission processing delay of the transmission device, and dr indicates a reproduction processing delay of the reproduction device.

The setting unit 24 sets the transmission delay Dt calculated by Expression (4) described above as the reproduction offset a. That is, the setting unit 24 acquires a PING value indicating the network delay, and sets the reproduction offset a based on the PING value. The setting unit 24 outputs the reproduction offset a to the reproducing unit 25.

The reproducing unit 25 acquires the current time output from the synchronizing unit 23, the reproduction offset a output from the setting unit 24, and the video data output from the buffer unit 21. The reproducing unit 25 outputs the video data to the subsequent device at a time at which the reproduction offset a is added to the RTP time stamp of the video data.

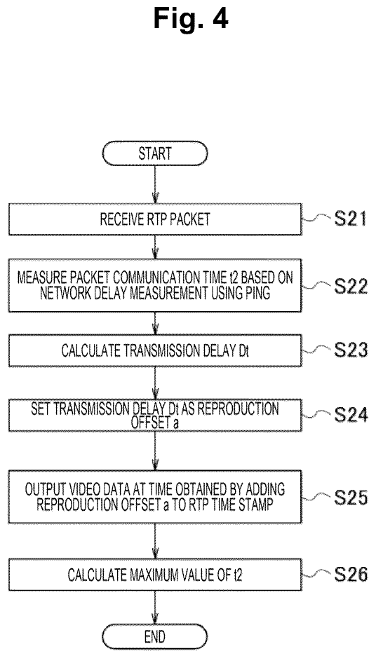

Next, an operation of the video reproduction device 102 according to the second embodiment will be described with reference to the flowchart illustrated in FIG. 4.

First, in Step S21 in FIG. 4, the buffer unit 21 receives an RTP packet transmitted from a transmission device (not illustrated) via a network. The RTP packet includes an RTP time stamp and video data. The buffer unit 21 outputs the RTP time stamp and the video data to the reproducing unit 25.

In Step S22, the network delay measuring unit 26 measures a packet communication time t2 between the transmission device and the video reproduction device 102 based on the network delay measurement using PING. The network delay measuring unit 26 outputs the packet communication time t2 to the setting unit 24.

In Step S23, the setting unit 24 calculates a transmission delay Dt by Expression (4) described above.

In Step S24, the setting unit 24 sets the transmission delay Dt as the reproduction offset a. The setting unit 24 outputs the reproduction offset a to the reproducing unit 25.

In Step S25, the reproducing unit 25 outputs the video data to the subsequent device at a time at which the reproduction offset a is added to the RTP time stamp of the video data.

In Step S26, the network delay measuring unit 26 calculates the maximum value of the packet communication times t2 calculated a plurality of times. Due to the maximum value within a predetermined time being set as the packet communication time t2, it is possible to set the reproduction offset a that enables avoidance of the influence of the delay jitter. As a result, it is possible to stably output the video data with a low delay.

As described above, in the video reproduction device 102 according to the second embodiment, the transmission delay Dt is calculated by using the PING value of the network, and the transmission delay Dt is set as the reproduction offset a. In addition, the packet communication time t2 is measured a plurality of times in order to consider the variation in the delay jitter, and the reproduction offset a is set by adopting the maximum value of the packet communication time t2. As a result, it is possible to stably output the video data with a low delay without being affected by delay jitter.

### Description of Third Embodiment

Next, a third embodiment will be described. In the third embodiment, an example in which an RTP packet is transmitted from a transmission device to a video reproduction device 103 by optical communication will be described.

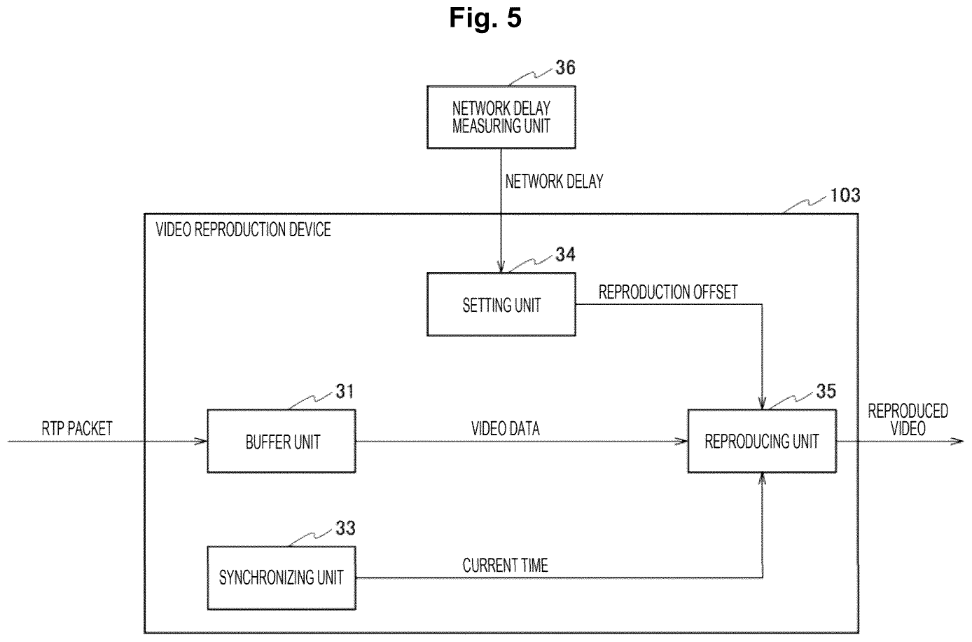

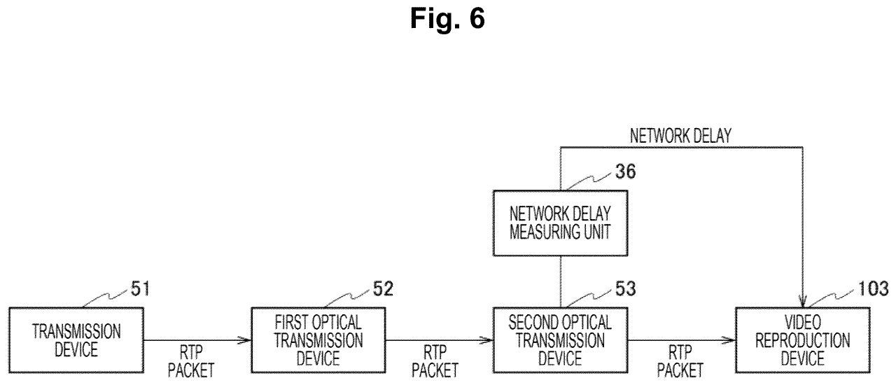

FIG. 5 is a block diagram illustrating a configuration of the video reproduction device 103 according to the third embodiment. FIG. 6 is a block diagram illustrating a configuration in which an RTP packet transmitted from a transmission device 51 is transmitted to the video reproduction device 103 by optical communication.

As illustrated in FIG. 6, the transmission device 51 is connected to a first optical transmission device 52 which is installed in a vicinity of the transmission device 51 in which a network delay is negligible. The video reproduction device 103 is connected to a second optical transmission device 53 which is installed in a vicinity of the video reproduction device 103 where a network delay is negligible. The second optical transmission device 53 includes a network delay measuring unit 36.

RTP packets are transmitted between the first optical transmission device 52 and the second optical transmission device 53 by optical communication based on “ITU-T G. 709”. In “ITU-T G. 709”, an optical channel data unit (ODU) round-trip delay t3 (a round-trip delay of optical communication) can be measured by using a Path Monitoring region in an ODU overhead. The ODU round-trip delay t3 is an example of a round-trip delay in optical communication.

It can be considered that ½ of the ODU round-trip delay t3 is a numerical value corresponding to the network delay dn in one direction (one way). However, it is assumed that the transmission device 51 and the first optical transmission device 52 are installed sufficiently close to each other, and the video reproduction device 103 and the second optical transmission device 53 are installed sufficiently close to each other, and a network delay therebetween is negligible. The network delay measuring unit 36 measures the ODU round-trip delay t3.

Note that, in the present embodiment, an example of adopting “ITU-T G. 709” will be described, but other optical communication may be adopted.

In the third embodiment, from the network delay measuring unit 36 installed in the second optical transmission device 53, the ODU round-trip delay t3 is acquired and t3/2 which is the network delay in one direction is acquired. In addition, the reproduction offset a is set based on this numerical value.

As illustrated in FIG. 5, the video reproduction device 103 includes a buffer unit 31, a synchronizing unit 33, a setting unit 34, and a reproducing unit 35.

The buffer unit 31 receives and temporarily stores an RTP packet. The buffer unit 31 outputs an RTP time stamp and video data included in the RTP packet to the reproducing unit 35.

The synchronizing unit 33 outputs the current time to the reproducing unit 35.

The setting unit 34 acquires an ODU round-trip delay t3 measured by the network delay measuring unit 36 described above. The setting unit 34 sets time that is ½ of the ODU round-trip delay t3 as the network delay dn. The setting unit 34 calculates a transmission delay Dt by Expression (5) below based on the ODU round-trip delay t3.

Dt=ds+dr+t3/2 (5)

Here, ds refers to a transmission processing delay of the transmission device, and dr refers to a reproduction processing delay of the reproduction device. In addition, the ODU round-trip delay t3 is not affected by delay jitter.

The setting unit 34 sets the transmission delay Dt calculated by Expression (5) described above as the reproduction offset a. That is, the setting unit 34 acquires a round-trip delay in optical communication, calculates a network delay in one direction from the round-trip delay, and sets the reproduction offset a based on the network delay in one direction. The setting unit 34 outputs the reproduction offset a to the reproducing unit 35.

The reproducing unit 35 acquires the current time output from the synchronizing unit 33, the reproduction offset a output from the setting unit 34, and the video data output from the buffer unit 31. The reproducing unit 35 outputs the video data to the subsequent device at a time at which the reproduction offset a is added to the RTP time stamp of the video data.

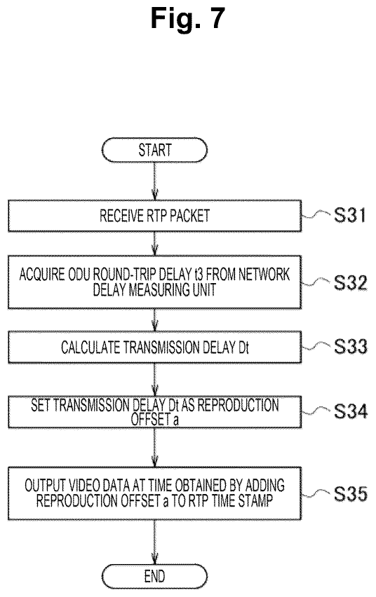

Next, an operation of the video reproduction device 103 according to the third embodiment will be described with reference to the flowchart illustrated in FIG. 7.

First, in Step S31 in FIG. 7, the buffer unit 31 receives an RTP packet transmitted from the transmission device 51. The RTP packet includes an RTP time stamp and video data. The buffer unit 31 outputs the RTP time stamp and the video data to the reproducing unit 35.

In Step S32, the setting unit 34 acquires an ODU round-trip delay t3 from the network delay measuring unit 36.

In Step S33, the setting unit 34 calculates a transmission delay Dt by Expression (5) described above.

In Step S34, the setting unit 34 sets the transmission delay Dt as the reproduction offset a. The setting unit 34 outputs the reproduction offset a to the reproducing unit 35.

In Step S35, the reproducing unit 35 outputs the video data to the subsequent device at a time at which the reproduction offset a is added to the RTP time stamp of the video data. In this way, it is possible to output video data with the reduced reproduction delay.

As described above, in the video reproduction device 103 according to the third embodiment, the transmission delay Dt is calculated based on the ODU round-trip delay t3 in optical communication, and the transmission delay Dt is set as the reproduction offset a. Therefore, it is possible to stably output video data without being affected by delay jitter.

Further, the video reproduction device 103 according to the third embodiment does not need to have a function of measuring the network delay therein, and can utilize a known measurement function installed outside. Therefore, it is possible to simplify the configuration of the video reproduction device 103.

### Description of Fourth Embodiment

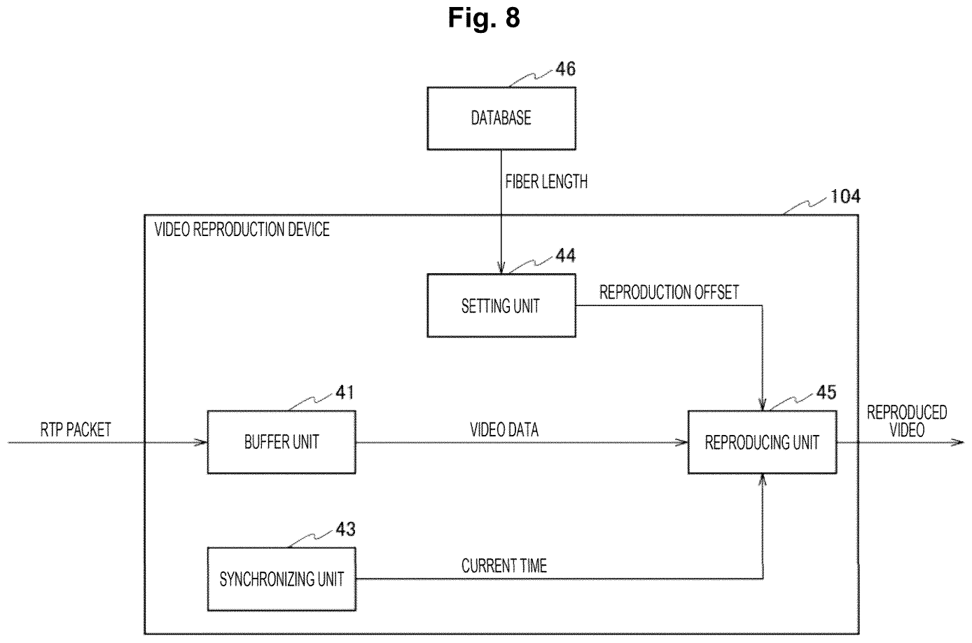

Next, a fourth embodiment will be described. FIG. 8 is a block diagram illustrating configurations of a video reproduction device 104 according to a fourth embodiment and a database 46 connected to the video reproduction device 104.

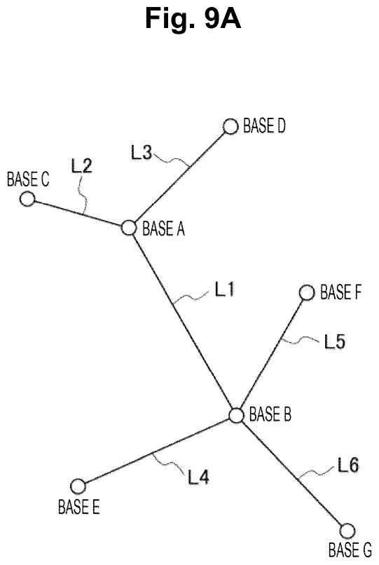

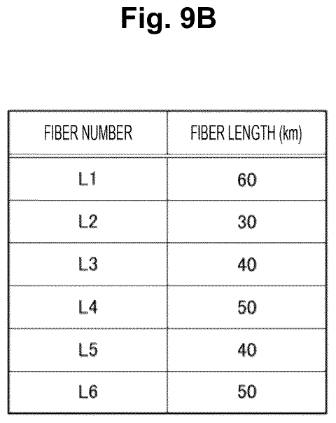

The database 46 stores the length of each fiber forming the network and the number of each fiber in association with each other. For example, in a case where a network configuration in which fibers L1 to L6 are connected to bases A to G as illustrated in FIG. 9A is provided, the respective fiber numbers L1 to L6 and the lengths of the respective fibers L1 to L6 are stored in association with each other as illustrated in FIG. 9B. For example, the length of the fiber L1 is stored as 60 [Km]. It is assumed that the fibers are connected by a patch in the bases A to G.

In the present embodiment, a network delay dn is calculated based on the fiber length.

A main factor of delay jitter included in the network delay dn is a random delay in a switching device such as an Ethernet switch or a router. Thus, in a case of a direct connection network that does not pass through the switching device, delay jitter can be suppressed small enough to be negligible. By using an optical transmission device (not illustrated) and a relay optical amplifier (not illustrated), it is possible to construct a direct connection network that does not pass through the switching device even over a long distance.

As illustrated in FIGS. 9A and 9B, it is possible to specify the total fiber length connecting optical transmission devices by storing the fiber lengths of the fibers L1 to L6 connecting the bases A to G in the database 46. Furthermore, it is possible to estimate the delay time based on the fiber length.

As illustrated in FIG. 8, the video reproduction device 104 includes a buffer unit 41, a synchronizing unit 43, a setting unit 44, and a reproducing unit 45. The setting unit 44 is connected to the database 46.

The buffer unit 41 receives and temporarily stores an RTP packet. The buffer unit 41 outputs an RTP time stamp and video data included in the RTP packet to the reproducing unit 45.

The synchronizing unit 43 outputs the current time to the reproducing unit 45.

When the RTP packet is received, the setting unit 44 refers to data on the fiber length stored in database 46 to calculate the total length of each fiber connecting the transmission device as a transmission source of the RTP packet and the video reproduction device 104.

Assuming that the fiber length of the fiber number Lk (k=1 to 6) illustrated in FIG. 9A is lk, the total fiber length X can be calculated by Expression (6) below.

$$[ Math . 1 ]$$

$$X = {\sum }_{k ∈ P} lk \qquad ( 6 )$$

Here, P refers to a set of fiber numbers through which video data passes. Assuming that there is the transmission device in the base A and there is the reproduction device in the base G, P=(1, 6).

For example, in a case where there is the transmission device in the base C illustrated in FIG. 9A and there is the video reproduction device 104 in the base B, the total length of the fibers L2 and L1 is a fiber length X. Specifically, as illustrated in FIG. 9B, since L2=30 [Km] and L1=60 [Km], the total fiber length X is 90 [Km].

The setting unit 44 calculates the transmission delay Dt by Expression (7) below based on the total fiber length X.

Dt=ds+dr+X/c (7)
where c indicates the speed of light in the fiber.

The setting unit 44 sets the transmission delay Dt calculated by Expression (7) described above as the reproduction offset a. The setting unit 44 outputs the reproduction offset a to the reproducing unit 45. That is, the setting unit 44 acquires the fiber length of a communication path of the packet, calculates the transmission delay Dt based on the fiber length, and sets the calculated transmission delay Dt as the reproduction offset a.

The reproducing unit 45 acquires the current time output from the synchronizing unit 43, the reproduction offset a output from the setting unit 44, and the video data output from the buffer unit 41. The reproducing unit 45 outputs the video data to the subsequent device at a time at which the reproduction offset a is added to the RTP time stamp of the video data.

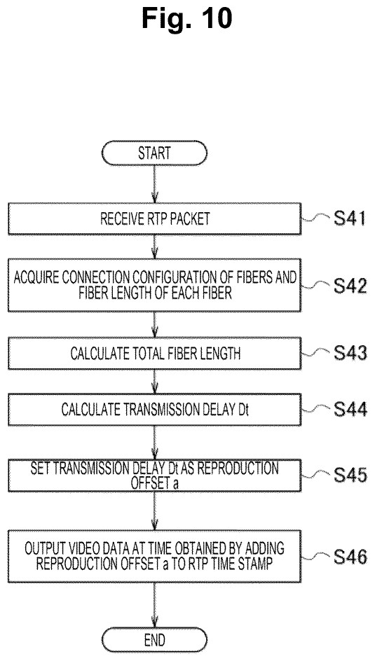

Next, an operation of the video reproduction device 104 according to the fourth embodiment will be described with reference to the flowchart illustrated in FIG. 10.

First, in Step S41 in FIG. 10, the buffer unit 41 receives an RTP packet transmitted from a transmission device (not illustrated) via a network. The RTP packet includes an RTP time stamp and video data. The buffer unit 41 outputs the RTP time stamp and the video data to the reproducing unit 45.

In Step S42, the setting unit 44 acquires the connection configuration of each fiber and the fiber length of each fiber from the database 46.

In Step S43, the setting unit 44 calculates the total fiber length between the transmission device and the video reproduction device 104 by Expression (6) described above, based on the connection configuration between the transmission device and the video reproduction device 104.

In Step S44, the setting unit 44 calculates a transmission delay Dt by Expression (7) described above.

In Step S45, the setting unit 44 sets the transmission delay Dt as the reproduction offset a. The setting unit 44 outputs the reproduction offset a to the reproducing unit 45.

In Step S46, the reproducing unit 45 outputs the video data to the subsequent device at a time at which the reproduction offset a is added to the RTP time stamp of the video data. In this way, it is possible to output video data with the reduced reproduction delay.

As described above, the video reproduction device 104 according to the fourth embodiment calculates the transmission delay Dt based on the total fiber length and sets the transmission delay Dt as the reproduction offset a. In addition, since the RTP packet is transmitted by the direct connection network without passing through the switching device, it is possible to suppress delay jitter small enough to be negligible. Therefore, it is possible to stably output the video data with a low delay without being affected by delay jitter.

In addition, in the video reproduction device 104 according to the fourth embodiment, the transmission delay Dt is calculated by using the data stored in the database 46. Therefore, it is possible to determine the reproduction delay in advance.

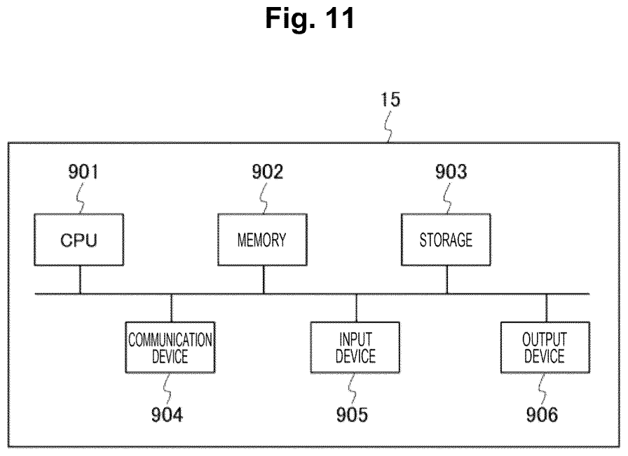

As the video reproduction devices 101 to 104 in the present embodiment described above, it is possible to use a general-purpose computer system including a central processing unit (CPU, processor) 901, a memory 902, a storage 903 (hard disk drive: HDD, solid state drive: SSD), a communication device 904, an input device 905, and an output device 906 illustrated in FIG. 11, for example. The memory 902 and the storage 903 are storage devices. In this computer system, the CPU 901 executes a predetermined program loaded on the memory 902, thereby implementing each function of the video reproduction devices 101 to 104.

Note that the video reproduction devices 101 to 104 may be mounted in one computer or may be mounted in a plurality of computers. In addition, the video reproduction devices 101 to 104 may be virtual machines that are implemented in a computer.

The program for the video reproduction devices 101 to 104 can be stored in a computer-readable recording medium such as an HDD, an SSD, a universal serial bus (USB) memory, a compact disc (CD), or a digital versatile disc (DVD), or can be distributed via a network. Examples of the computer-readable recording medium include a non-transitory recording medium.

The present disclosure is not limited to the above embodiment, and numerous modifications are available within the scope and gist of the invention.

### REFERENCE SIGNS LIST

11, 21, 31, 41 Buffer unit
12, 26, 36 Network delay measuring unit
13, 23, 33, 43 Synchronizing unit
14, 24, 34, 44 Setting unit
15, 25, 35, 45 Reproducing unit
46 Database
51 Transmission device
52 First optical transmission device
53 Second optical transmission device
101, 102, 103, 104 Video reproduction device

1. A video reproduction device comprising:
a buffer unit, including one or more processor, configured to receive and store a packet transmitted via a network;
a setting unit, including one or more processor, configured to set a reproduction offset which enables reproduction of video data included in the packet according to a condition of the network; and
a reproducing unit, including one or more processor, configured to delay the video data by the reproduction offset and output the delayed video data.

2. The video reproduction device according to claim 1, further comprising:
a network delay measuring unit, including one or more processor, configured to measure a difference time between a time stamp included in the packet and a current time and calculate a network delay based on the measurement of the difference time, wherein
the setting unit configured to set the reproduction offset based on the network delay.

3. The video reproduction device according to claim 1, wherein
the setting unit configured to acquire a PING value indicating a network delay, and set the reproduction offset based on the PING value.

4. The video reproduction device according to claim 1, wherein
the packet is transmitted from a transmission device by optical communication, and
the setting unit configured to acquire a round-trip delay in the optical communication, calculate a network delay in one direction from the round-trip delay, and set the reproduction offset based on the network delay in the one direction.

5. The video reproduction device according to claim 1, wherein
the setting unit configured to acquire a fiber length of a communication path of the packet, calculate a network delay based on the fiber length, and set the calculated network delay as the reproduction offset.

6. A video reproduction method performed by a video reproduction device comprising:
receiving a packet transmitted via a network;
setting a reproduction offset that enables reproduction of video data included in the packet according to a condition of the network; and
delaying the video data by the reproduction offset and outputting the delayed video data.

7. A non-transitory computer-readable storage medium storing a video reproduction program for causing a computer to function as the video reproduction device according to claim 1.
